(19) United States
(12) Patent Application Publication
(10) Pub. No.: US 2016/0133894 A1
(43) Pub. Date: May 12, 2016

(54) ELECTROCHEMICAL CELL

(71) Applicant: Seiko Instruments Inc., Chiba-shi (JP)

(72) Inventors: Takashi ONODERA, Chiba-shi (JP); Ryo SATO, Chiba-shi (JP); Tadahito SUZUKI, Chiba-shi (JP)

(21) Appl. No.: 14/884,042

(22) Filed: Oct. 15, 2015

(30) Foreign Application Priority Data
Nov. 11, 2014 (JP) 2014-228615

(51) Int. Cl. H01M 2/10; H01G 11/78; H01G 11/74; H01M 2/20

(52) U.S. Cl. CPC H01M 2/1061; H01M 2/20; H01G 11/78; H01G 11/74; H01M 2220/30

(57) ABSTRACT

An electrochemical cell includes at least a base container, a cell which is accommodated in the base container, a plurality of cell leads which are extension portions of the cell, a pad film which is formed of valve metal on a base bottom surface, and a base-embedded wiring (a via wiring) which is connected to the pad film and is formed in a portion between the base bottom surface and a base lower surface, in which at least one of the cell leads and the pad film are fixed to each other through ultrasonic welding, and when a horizontal distance between a welding portion and the base-embedded wiring in the pad film is set to be L, and tolerance relating to an installation position of the base-embedded wiring is set to be a, L≧a×1.3 is established.

### RELATED APPLICATIONS

This application claims priority under 35 U.S.C. §119 to Japanese Patent Application No. 2014-228615 filed on Nov. 11, 2014, the entire content of which is hereby incorporated by reference.

### BACKGROUND OF THE INVENTION

1. Field of the Invention

The present invention relates to an electrochemical cell capable of being mounted on a surface.

2. Background Art

The electrochemical cell has been used as a backup power supply for a semiconductor memory and as a preparatory power supply for an electronic device such as a micro computer and an IC memory. These electrochemical cells are required to be reduced in size, but a discharge current thereof is only in a range from several μA to several mA. Meanwhile, in recent years, new applications for causing a light source such as an LED which is provided in the electronic device to blink and for intermittently driving a small motor have appeared. For this reason, an increase in the discharge current is required. In response to this, as disclosed in JP-A-2013-30750, an electrochemical cell which has a small external container and is capable of discharging currents in a range of several hundred mA to several A has been proposed.

In the electrochemical cell disclosed in JP-A-2013-30750, a pad film which is formed of a valve metal is formed on the bottom surface of a base container, and the pad film and a cell lead extending from a cell (an element) are welded to each other through ultrasonic welding, laser beam welding, or the like. In addition, base-embedded wirings (via wiring) are provided on a lower surface of the pad film. Here, at the time of welding the pad film and the cell lead, pressure, heat, and vibration are generated in the vicinity of the welding portion on the pad film. Particularly, in a case where the welding portion and the via wiring are overlapped with or are close to each other, adhesion between the pad film and the external container or between the pad film and the via wiring is deteriorated and cracks or tears occur in the pad film itself. For this reason, the pad film cannot function as a protective film for the via wiring, and thus an upper end surface of the via wiring is exposed to the inside of the package and comes in contact with an electrolyte and thereby the via wiring is eluted in the electrolyte. Due to this, the electrochemical cell ends up losing the electrical connection.

### SUMMARY OF THE INVENTION

In this regard, an object of the present invention is to provide an electrochemical cell which is small, has high reliability, and is suitable for a large current discharge by alleviating influences of pressure, heat, and vibration generated at the time of welding a pad film and a cell lead which are provided on the bottom surface of a base container so as to maintain functions of the pad film.

Aspect 1

According to Aspect 1 of the invention, there is provided an electrochemical cell 1 including at least a base container 2, a cell 6 which is accommodated in the base container 2, a plurality of cell leads 8 which are extension portions of the cell 6, a pad film 5 which is formed of valve metal on a bottom surface (a base bottom surface 2c) of the base container 2, and a base-embedded wiring (a via wiring 3) which is connected to the pad film 5 and is formed in a portion between the bottom surface 2c and a lower surface (a base lower surface 2d) of the base container 2, in which at least one of the cell leads 8 and the pad film 5 are fixed to each other through ultrasonic welding, and when a horizontal distance between a welding portion 5a and the base-embedded wiring 3 in the pad film 5 is set to be L, and tolerance relating to an installation position of the base-embedded wiring 3 is set to be a, L≧a×1.3 is established.

In the invention, the pad film 5 is provided to fix the cell lead 8, and protect the base-embedded wiring (the via wiring 3) from being exposed to the base bottom surface 2c.

According to the invention, when considering the tolerance a relating to the installation position of the base-embedded wiring 3, the pad film 5 and the base-embedded wiring 3 are disposed on the base bottom surface 2c in such a manner that the horizontal distance L between the welding portion 5a and the base-embedded wiring 3 in the pad film 5 satisfies a relationship of L≧a×1.3. With such a configuration, it is possible to avoid the influence of the pressure, heat, and vibration which are generated at the time of welding the pad film 5 and the cell lead 8. Due to this, since the adhesion with respect to the base bottom surface 2c or the base-embedded wiring 3 of the pad film 5 is not deteriorated and cracks or tear does not occur in the pad film 5 itself, it is possible to secure the electrical connection between the pad film 5 and the base-embedded wiring 3, and to reliably protect the base-embedded wiring 3 from the electrolyte 7.

Aspect 2

According to Aspect 2 of the invention, there is provided an electrochemical cell 1 including at least: a base container 2; a cell 6 which is accommodated in the base container 2; a plurality of cell leads 8 which are extension portions of the cell 6; a pad film 5 which is formed of valve metal on a bottom surface (a base bottom surface 2c) of the base container 2; and a base-embedded wiring (a via wiring 3) which is connected to the pad film 5 and is formed in a portion between the bottom surface 2c and a lower surface (a base lower surface 2d) of the base container 2, in which at least one of the cell leads 8 and the pad film 5 are fixed to each other through ultrasonic welding, and when a horizontal distance between a welding portion 5a and the base-embedded wiring 3 in the pad film 5 is set to be L, tolerance relating to an installation position of the base-embedded wiring 3 is set to be a, and tolerance in a position of the welding portion 5a in the pad film 5 is set to be b, L≧(a+b)×1.026 is established.

In the invention, the pad film 5 is provided to fix the cell lead 8, and protect the base-embedded wiring (the via wiring 3) from being exposed to the base bottom surface 2c.

According to the invention, when considering the tolerance a relating to the installation position of the base-embedded wiring 3 and the tolerance b of the position of the welding portion 5a in the pad film 5, the pad film 5 and the base-embedded wiring 3 are disposed on the base bottom surface 2c in such a manner that the horizontal distance L between the welding portion 5a and the base-embedded wiring 3 in the pad film 5 satisfies a relationship of L≧(a+b)×1.026. With such a configuration, it is possible to avoid the influence of the pressure, heat, and vibration which are generated at the time of welding the pad film 5 and the cell lead 8. Due to this, since the adhesion with respect to the base bottom surface 2c or the base-embedded wiring 3 of the pad film 5 itself is not deteriorated and cracks or tear does not occur in the pad film 5, it is possible to secure the electrical connection between the pad film 5 and the base-embedded wiring 3, and to reliably protect the base-embedded wiring 3 from the electrolyte 7.

According to the present invention, it is possible to provide an electrochemical cell which is small, has high reliability and is suitable for a large current discharge by alleviating influences of pressure, heat, and vibration generated at the time of welding a pad film and a cell lead which are provided on the bottom surface of a base container so as to maintain functions of the pad film.

### BRIEF DESCRIPTION OF THE DRAWINGS

FIGS. 1A and 1B are diagrams illustrating an electrochemical cell of an embodiment.

FIGS. 2A and 2B are diagrams illustrating a relationship between of a pad film, a via wiring, and a connection terminal of the electrochemical cell in the embodiment.

FIGS. 3A and 3B are diagrams illustrating welding between a cell lead and the pad film of the electrochemical cell in the embodiment.

FIG. 4 is a diagram illustrating tolerance in a welding range of the via wiring of the electrochemical cell of the embodiment.

FIG. 5 is a flow chart illustrating a manufacturing flow of the electrochemical cell of the embodiment.

FIGS. 6A to 6c are diagrams illustrating Modification Example 1 of the electrochemical cell of the embodiment.

FIGS. 7A to 7C are diagrams illustrating Modification Example 2 of the electrochemical cell of the embodiment.

FIGS. 8A and 8B are diagrams illustrating Modification Example 3 of the electrochemical cell of the embodiment.

FIGS. 9A to 9C are diagrams illustrating Modification Example 4 of the electrochemical cell of the embodiment.

FIG. 10 is a diagram illustrating Modification example 5 of the electrochemical cell of the embodiment.

FIGS. 11A and 11B are diagrams illustrating the size of each portion of the electrochemical cell of the embodiment.

### DETAILED DESCRIPTION OF THE INVENTION

An electrochemical cell 1 of the embodiment will be described with reference to the drawings. The electrochemical cell 1 of the embodiment is mainly used by being mounted on a substrate in a personal computer or a compact-sized portable device.

Electrochemical Cell 1

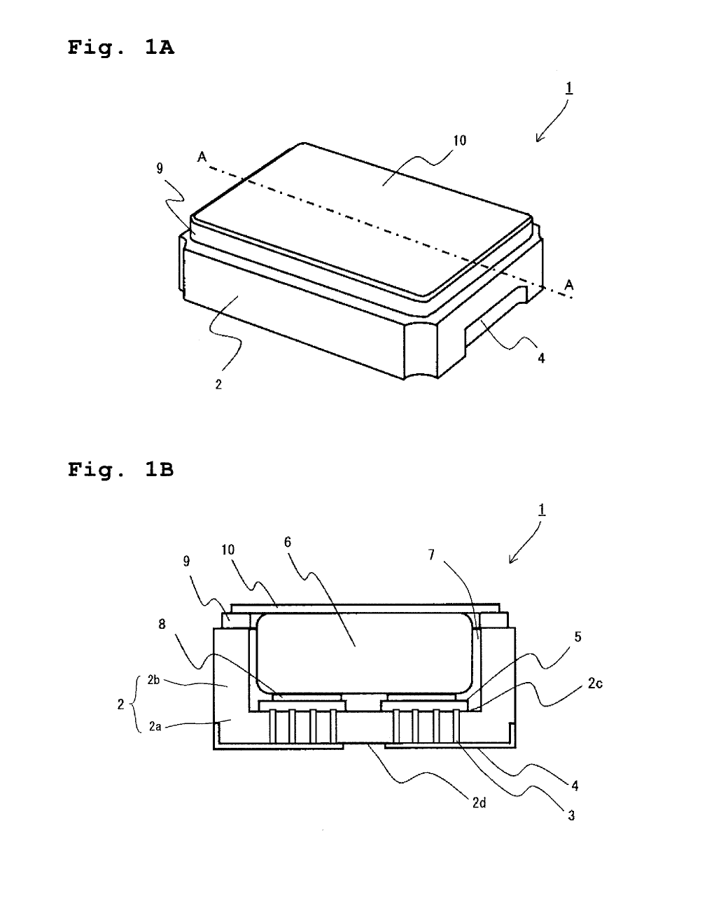

FIG. 1A is a diagram illustrating the appearance of the electrochemical cell 1 of the embodiment. Although the electrochemical cell 1 is shown in a rectangular parallelepiped shape as an example, it may have a track shape or a cylindrical shape. The electrochemical cell 1 of the embodiment is provided with, as external components, a base container 2 which functions as a container accommodating a cell 6 which is a power generating element for the electrochemical cell 1, and a lid 10 which functions as a sealing plate for air-tightly sealing an opening portion of the base container 2. The external container of the electrochemical cell 1 of the embodiment is formed of the base container 2 and the lid 10 which seals the opening portion of the base container 2.

FIG. 1B is a diagram illustrating a cross section taken along line A-A in FIG. 1A. The cell 6 is accommodated in the concave base container 2, then the base container 2 is filled with an electrolyte 7, and is air-tightly sealed by the lid 10 pressing against a sealing ring 9 which is provided so as to surround the periphery of an upper surface of the concave base container 2. Pad films 5 which are a pair of collector metal films are disposed in parallel with each other on a base bottom surface 2c of the concave base container 2. In addition, a plurality of via wirings 3 are formed on the bottom surface of the pad film 5, that is, over the base bottom surface 2c to a base lower surface 2d. The via wiring 3 is electrically connected to the pad film 5 and a connection terminal 4 which is formed on the base lower surface 2d.

Meanwhile, the cell 6 is accommodated in the external container. The cell 6 is formed of a pair of electrode sheets which are formed of an active material and a metallic collector supporting the active material, and formed by interposing an insulating separator between the electrode sheets through a winding method or a laminating method. Cell leads 8 are formed at end portions of the collectors of a positive electrode and a negative electrode. Each of the cell leads 8 of the positive electrode and the negative electrode is fixed to each of a pair pad films 5 through welding. The positive electrode and the negative electrode of the cell 6 are electrically connected to a mounting pattern of a substrate on which the cell is mounted via the connection terminal 4.

Base Container 2

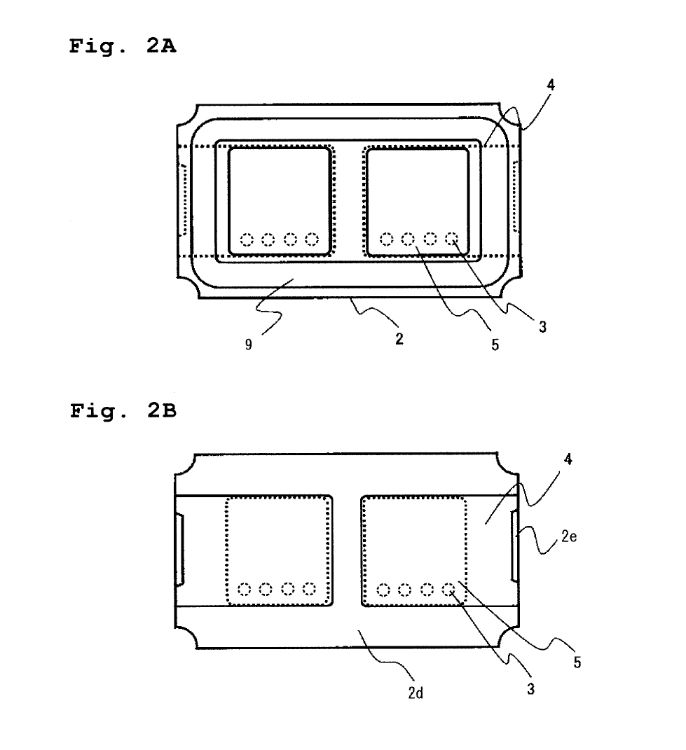

The base container 2 is a container which is formed of a ceramic box which is opened upwardly, and includes a rectangular base bottom portion 2a, and a rectangular frame-shaped base wall portion 2b which is installed in the outer periphery of the base bottom portion 2a. The size of the base container 2 can be set such that a side thereof is about 5 mm to 20 mm, and the height is about 1 mm to 3 mm. FIGS. 2A and 2B are diagrams respectively illustrating the base bottom surface 2c of the base container 2 and the base lower surface 2d. A pair of pad films 5 which are formed of a conductive material are disposed on the base bottom surface 2c as illustrated in FIG. 2A. Four via wirings 3 which are indicated with broken lines are respectively provided on the lower surface of the pad film 5, and are perpendicularly connected to the connection terminal 4 (also shown with the broken line) which is disposed on the base lower surface 2d.

Meanwhile, examples of a material of the base container 2 include ceramics containing at least one material selected from alumina, silicon nitride, zirconia, silicon carbide, aluminum nitride, mullite, and a group consisting of composite materials thereof, but is not limited thereto. It is also possible to use soda-lime glass, heat-resistant glass, and the like. Since long glass can be used as the material, in the case of a small package, it is possible to obtain many packages with one sheet of glass. Therefore, the reduction in the cost of a base material can be expected.

The base container 2 in the embodiment is formed by bonding a ceramic green sheet corresponding to the wall portion 2b which is formed into a rectangular frame shape to a ceramic green sheet corresponding to the bottom portion 2a which is formed into a rectangular shape, and then baking the bonded sheets. Note that, it is possible to form a through hole by punching a hole in advance through the ceramic green sheet corresponding to the bottom portion 2a.

Via Wiring 3

The via wiring 3 is a wiring which is formed from the base bottom surface 2c of the base container 2 to the base lower surface 2d. The via wiring 3 is formed in such a manner that, first, the through hole, which passes through in a substantially vertical direction and connects the base bottom surface 2c and the base lower surface 2d, is provided in the base bottom portion 2a, and the through hole is filled with a paste of tungsten. In addition, the through hole is air-tightly sealed by the via wiring 3.

Meanwhile, examples of the paste used to bond a via wiring 6b include a paste obtained by mixing carbon and resin, and a paste obtained by mixing tungsten, molybdenum, nickel, gold, or a composite material thereof and resin.

The paste with which the through hole is filled becomes the via wiring 3 by being baked together with the ceramic green sheet which becomes the base container 2.

As described above, when the base container 2 is formed of a glass material such as the soda-lime glass or the heat-resistant glass, examples of a means of forming a concave portion or the through hole on the aforementioned glass include a chemical etching method and a physical method such as sand blasting, or it is possible to form the concave portion and the through hole at the same time by using a mold in the atmosphere at a high temperature. In addition, an aluminum film is formed on the inner surface of the through hole, the through hole is filled with glass paste having an identical coefficient of thermal expansion, and then debinding and baking are performed so as to form the via wiring 3 having conductivity in an airtight manner. In such a case, there is no concern in that the via wiring 3 will be dissolved by the electrolyte 7. In addition, a film forming the inner surface of the via wiring 3 may include the valve metal such as titanium without being limited to aluminum.

Connection Terminal 4

A pair of connection terminals 4 are provided on the base lower surface 2d illustrated in FIG. 2B so as to face the pad film 5. The connection terminal 4 is fixed to a substrate by using a cream solder provided in a pattern of a mounting substrate through a reflow process or the like.

In the embodiment, the pattern of the electrode, which is formed of tungsten, is printed on the ceramic green sheet corresponding to the base container 2 in advance, and then the ceramic green sheet is baked so as to form the connection terminal 4. In addition, in the connection terminal 4, a plating film which is formed of nickel and gold is applied to the pattern which is formed of tungsten through a printing method. Further, tungsten or plating materials function as a portion of the connection terminal by being patterned in the concave portion of the base side surface 2e.

Pad Film 5

The pad film 5 is formed into a substantially rectangular shape and formed of a conductive material which is disposed in two places on the base bottom surface 2c. The pad film 5 prevents the upper end portion of the via wiring 3 and the electrolyte 7 from directly coming in contact with each other, and includes a welding portion 5a for connecting the cell lead 8 through the welding. Note that, the pad films 5 in the embodiment are disposed to in parallel with each other in the longitudinal direction of the base container 2, but can be disposed in parallel with each other in a short side direction or in a direction diagonal to the longitudinal direction.

The pad film 5 is formed of chemically stable valve metal such as aluminum or titanium, and the material thereof is less likely to be dissolved in the electrolyte 7. The aforementioned film, for example, can be provided through a well-known film forming method such as a vapor deposition method, an ion plating method, or a sputtering method. When using the above-described methods, the film is formed by, first, baking metal such as tungsten with which the through hole is filled through the printing method or the like, and then forming the airtight via wiring 3. When the film is formed in a vacuum, for example, in order to form both a positive pad film 5 and a negative pad film 5, a mask made of metal or the like, which is patterned so as to have two openings spatially separated from each other, is prepared and accommodated in a chamber of a formed film, the chamber is evacuated to a predetermined degree of vacuum in an evacuation system, and the mask is evaporated together with the valve metal material or a target which is formed of the valve metal material is physically ionized so as to blow off the material, thereby forming a film on the base bottom surface 2c. Since film formation conditions are easily controlled in these film forming methods, it is possible to form a high density film which has low resistivity and through which a liquid does not easily penetrate.

In addition, the aluminum film can be also formed through a screen printing method. A technology capable of forming a wiring pattern at a temperature of 150° C. or lower even in the case of aluminum which is likely to be oxidized at a high temperature has been developed. In comparison to thin film forming technologies such as an evaporation method, a thick film having a thickness of a few tens of microns is more easily formed in the printing method.

Further, the aluminum film can be manufactured through an electroplating method. It is known that a film which is formed with a thickness of about 40 μm by using a plating solution formed of dimethyl sulfone and aluminum chloride has a smooth surface and even thickness of the interior of the film.

Subsequently, the thickness of the pad film 5 will be described. The film thickness is preferably within a range of 5 μm or more to 100 μm or less. More preferably, the film thickness is within a range of 10 μm or more to 30 μm. This is because that if the film is thin, fine pores existing in the film are connected to each other, the electrolyte 7 penetrates through the tungsten at the bottom of the pad film, and thus electrolytic corrosion of the tungsten is likely to occur, and as described below, when the film is connected to the cell lead 8 through the welding, the welding conditions are extremely difficult to achieve, and thus it is difficult to achieve reliable bonding.

Here, the following test is performed. The aluminum film of which the thickness of the pad film 5 is 5 μm is formed on a soda-lime glass substrate having a thickness of about 1.3 mm, through an ion plating method, and thereafter, a thin aluminum sheet having a thickness of 80 μm is welded through the ultrasonic welding. Minute cracks occurring on the glass substrate of one sample out of five cell leads is found. Accordingly, 5 μm is a practical lower limit value of the film thickness. In practice, the film thickness is preferably 10 μm or greater.

On the other hand, an evaporating rate of aluminum obtained through the evaporation method or the ion plating method is within a range of 3 μm to 10 μm per hour. In consideration of an evaporation time, the thickness is preferably 30 μm or less, and a film forming time in this case is about four or five hours at the longest. In a case where the film thickness is up to 100 μM, it takes long time to form the film, but it is possible to have a wide range of welding conditions when connecting the cell lead 8 through the welding, and thus it is less likely that the crack will occur in the ceramics corresponding to the base.

Cell 6

Next, the cell 6 will be described. The cell 6 is a power generating element obtained by the following method; aluminum foil or copper foil which has a thickness of 5 μm to 50 μm is set as a collector, and a pair of positive and negative electrode sheets, which support the active material at the surface thereof through a coating or bonding method, are integrated through a process such as winding, laminating, or folding while interposing a separator formed of an insulating material therebetween.

In the case of an electric double layer capacitor, activated carbon or carbon can be exemplified as a representative example of the active material. In a lithium ion secondary battery, examples of a positive electrode active material include a compound such as lithium cobalt oxide (LiCoO₂), lithium nickelate (LiNiO₂), lithium manganate (LiMn₂O₄), and lithium iron phosphate (LiFePO₄), and examples of a negative electrode active material include a silicon oxide in addition to graphite, and coke. An active material paste is obtained by mixing a conductive auxiliary agent, a binder, and a dispersant into the above active material and then adjusting the obtained mixture to an appropriate viscosity, and then the active material paste is coated on one or both surfaces of the collector through a method such as a roller coating method, a screen coating method, and a doctor blade method. After coating, the electrode sheet is formed through a process of drying and pressing.

The separator controls the positive electrode and the negative electrode so as not to directly come in contact with each other. An insulating film having large ion permeability, and a predetermined mechanical strength is used as the separator. For example, in an environment where heat resistance is required, in addition to glass fibers, it is possible to use a resin such as polytetrafluoroethylene, polyphenylene sulfide, polyethylene terephthalate, polyamide, and polyimide. In addition, the thickness and the hole size of the separator are not particularly limited, but are determined based on a current value of the equipment being used and the internal resistance of the electrochemical cell 1. Further, it is also possible to use a porous body of ceramics as the separator.

Electrolyte 7

The electrolyte 7 is preferably liquid-like or gel-like and is used for a known electric double layer capacitor or a non-aqueous electrolyte secondary battery.

Examples of an organic solvent used in the liquid and gel electrolyte 7 include acetonitrile, diethyl ether, diethyl carbonate, dimethyl carbonate, 1,2-dimethoxyethane, tetrahydrofuran, propylene carbonate (PC), ethylene carbonate (EC), γ-butyrolactone (γBL), sulfolane, propionic acid ester, and chain sulfone, and it is possible to use any one or a mixture thereof.

In particular, a substance which contains a main solvent having a high boiling point, such as propylene carbonate (PC), ethylene carbonate (EC), or γ-butyrolactone (γBL), and sulfolane, and propionic acid ester and chain sulfone as a sub solvent is suitable but is not limited thereto.

Examples of a material used in the liquid and gel electrolyte 7 include (C₂H₅)₄PBF₄, (C₃H₇)₄PBF₄, (CH₃)(C₂H₅)₃NBF₄, (C₂H₅)₄NBF₄, (C₂H₅)₄PPF₆, (C₂H₅)₄PCF₃SO₄, (C₂H₅)₄NPF₆, lithium perchlorate (LiClO₄), lithium hexafluorophosphate (LiPF₆), lithium borofluoride (LiBF₄), hexafluoroarsenate lithium (LiAsF₆), trifluoroacetic meth lithium sulfonate (LiCF₃SO₃), bis (trifluoromethylsulfonyl)imide lithium [LiN (CF₃SO₂)₂], thiocyanate salt, aluminum fluoride salt, and lithium salt. Examples of the supporting electrolyte of the liquid electrolyte 7 include quarternary ammonium salt, quarternary phosphonium salt, and the like. Examples of the quarternary ammonium salt include a compound having only a fatty chain, an alicyclic compound having a fatty chain and an aliphatic ring, and a Spiro compound having only an aliphatic ring. Particularly, 5-azoniaspiro[4,4]nonane tetrafluoroborate (spiro-(1,1′)-bipyrrolidinium: SBP-BF4), which is the Spiro compound and has high electrical conductivity, is suitable for the quarternary ammonium salt, but the example of the quarternary ammonium salt is not limited thereto.

In addition, the gel electrolyte 7 is obtained by impregnating the liquid electrolyte with a polymer gel. Examples of the polymer gel include polyethylene oxide, polymethacrylic acid methyl, and polyvinylidene fluoride, but are not limited thereto.

Furthermore, a pyridine-based ionic liquid or an alicyclic amine-based ionic liquid, an aliphatic amine-based ionic liquid or an imidazolium based ionic liquid or amidine-based ambient temperature molten salt may be used as the polymer gel.

Cell Lead 8

The cell lead 8 is a terminal for extracting electric power from the cell 6. An example of the cell lead 8 is an extension portion formed by extending the collector to be thinned, or an extension portion by being formed mechanically connected to a separate thin plate or a wire shaped lead. The cell lead 8 in the embodiment is obtained by extending the collector, and the welded area 8a which is a part of the cell lead 8 is fixed to the welding portion 5a on the pad film 5 through the welding.

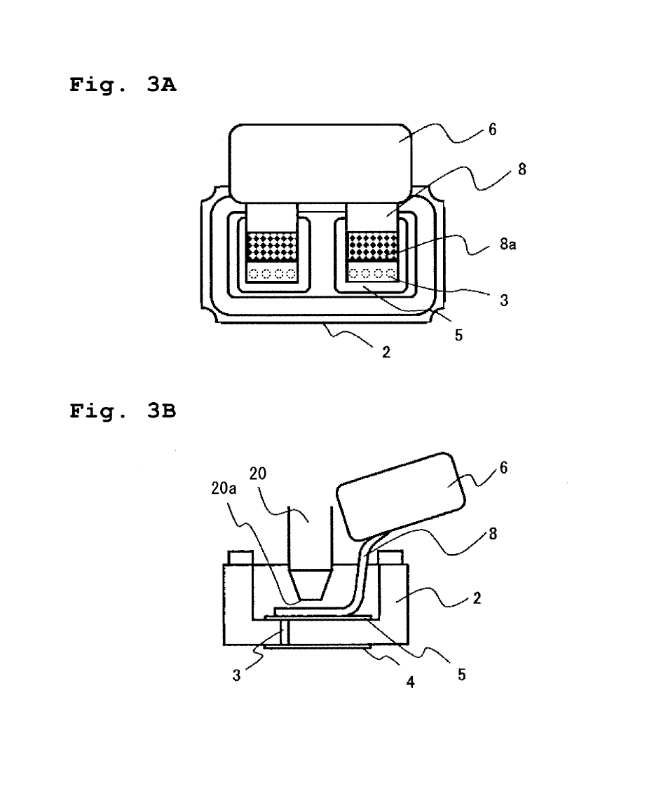

The cell lead 8 of the embodiment has sufficient length to place the cell 6 on the outside of the base container 2, as illustrated in FIG. 3A, and it is desired that the cell 6 is set to have a length which does not interfere with a movement of a chip 20 for welding at the time of welding the pad film 5. This is because the internal resistance is increased if the length is excessively long.

Meanwhile, the cell 6 is accommodated in the base container 2 after welding the cell lead 8 and the pad film 5. At this time, the cell lead 8 is folded in the base container 2. In addition, when folding the cell lead 8, in order to avoid a short-circuit in the cell 6, it is necessary to be careful that the cell lead 8 is not mixed with the sealing ring 9.

Welding Method of Cell Lead 8

Next, a method of welding the cell lead 8 and the pad film 5 will be described in detail with reference to FIGS. 3A and 3B. FIG. 3A is a diagram illustrating a pair of cell leads 8 and a pair pad films 5 which are connected to the cell 6. The tip ends of a pair of cell leads 8, as illustrated in FIG. 3A, are disposed on the surface of the pad film 5, and then are welded to the pad film 5 from the upper surface of the cell lead 8, and thereby the pad film 5 and the cell lead 8 are bonded to each other. Through the welding, atomic diffusion of the material forming the respective members occurs on a bonded interface between the cell lead 8 and the pad film 5, and thus, it is possible to firmly bond the pad film 5 and the cell lead 8. The welded area 8a in FIG. 3A schematically illustrates a welded part. Through the welding, it is possible to perform the bonding with sufficiently low connection resistance of mΩ or less even if there is contamination such as a natural oxide film on the bonded interface. Because of this, it is possible to reduce the connection resistance to be from 1/10 to 1/100 unlike in the bonding method performed by using a conductive adhesive. In addition, it is possible to suppress variation in the connection resistance values, and it is possible to perform the bonding with a small change over time.

In addition, by enlarging areas of the welding portion 5a and the welded area 8a, it is possible to further reduce the connection resistance value and to improve tensile strength between the cell lead 8 and the pad film 5. For this reason, in a manufacturing process of accommodating the cell 6 in the container by deforming the cell lead 8, it is possible to suppress defects such as peeling-off of the welding, and to improve the mechanical reliability such as the vibration resistance or drop impact characteristics of the completed electrochemical cell 1.

Examples of the method of welding the cell lead 8 and the pad film 5 include a local welding method such as ultrasonic welding, beam welding, and resistance welding. That is, in these welding methods, since a portion to be welded is localized, thermal effects remain only in the vicinity of the welding portion 5a, and the influence on the cell 6 itself can be avoided. Further, it is possible to reduce the influence on components due to the mechanical or thermal shock of the welding by changing the material and the thickness of the cell lead 8, the material of the pad film 5, and the arrangement of the through hole of the pad film 5. With such a configuration, it is possible to avoid damage to the members due to the occurrence of cracks on the base container 2 made of a material such as ceramics.

In the embodiment, the ultrasonic welding is chosen from the above-described welding methods. FIG. 3B is a diagram illustrating a specific method of the ultrasonic welding. In the ultrasonic welding, first, the cell lead 8 is positioned and fixed on the pad film 5, and at this time, the cell 6 is placed on the outside of the base container 2 and does not interfere with movement of a chip 20 for ultrasonic welding. Next, the chip 20 for the ultrasonic welding comes in contact with the upper surface of the cell lead 8 through the appropriate welding pressure applied by a moving mechanism. The chip 20 for the ultrasonic welding is integrally formed or separately formed at a tip end of a horn. A tip end 20a of the chip 20 for the ultrasonic welding is a portion coming in contact with the cell lead 8, and here, it is preferable that an uneven pattern is formed on a surface of the cell lead 8 so as to properly etch the surface (a knurl process).

After the chip 20 for the ultrasonic welding comes in contact with the cell lead 8 with the appropriate welding pressure, and when a vibration mechanism of an ultrasonic welding machine applies ultrasonic waves having a tendency of several tens of kHz to the horn, the chip 20 for the ultrasonic welding rubs bonded parts together with a certain frequency. Because of this, interface between a welded area 8a of the cell lead 8 and a welding portion 5a of the pad film 5 becomes an adhering surface for clean surfaces of the metallic material, and it is possible to perform pressure-welding for a short period of several tens of milliseconds to several hundred milliseconds. The uneven pattern of the surface of the cell lead 8 which is indicated in the welded area 8a of FIG. 3A schematically illustrates that the uneven pattern on the chip 20 for the ultrasonic welding is transferred through the ultrasonic welding. The area indicated by the uneven pattern becomes the welded area 8a, but when viewed microscopically, the bonded part corresponds to only a recessed portion made by the convex portion which is processed as the tip end of the chip 20 for the ultrasonic welding, and other areas have a small gap between the cell lead and the pad film.

Meanwhile, when the chip 20 for the ultrasonic welding comes in contact with the surface of the cell lead 8, it is preferable to take caution so as not to cause a large shock, and it is preferable that the moving mechanism is provided with a shock absorbing mechanism such as a damper. Due to this, it is possible to reduce the damage to the base material.

Note that, in the ultrasonic welding, it is possible to use not only the vibration, but also the thermal energy and a mechanical pressing force. In addition, FIG. 3A illustrates an example of a thin plate as the cell lead 8, but the cell lead 8 may be a wire or the chip 20 for the ultrasonic welding may be properly deformed.

In addition, one cell lead 8 is welded with one pad film, but the number of the cell leads 8 may be two or more. In a case where the length of the collector supporting the active material is long, it is possible to provide a plurality of cell leads to the collector. This case is preferable since it is possible to reduce the resistance values when the plurality of cell leads 8 can be connected to one pad film.

Welding Condition

It is possible to correspond to the various sizes of the electrochemical cell 1 by properly selecting sizes (the width and the thickness of the lid) of the cell lead 8 and sizes of the pad film 5 (the longitudinal and lateral sizes and thicknesses) and a size of the chip 20 for the ultrasonic welding. It is sufficient if the width of the welded area 8a illustrated in FIG. 3A is 0.5 mm, which is advantageous to the condition of manufacturing the compact-sized electrochemical cell 1. In addition, in order to increase the mechanical strength thereof, by properly setting the welding conditions even when performing the ultrasonic welding by using the chip 20 for the ultrasonic welding which is designed so as to cover the surface area of the pad film 5 as widely as possible, it is possible to obtain sufficiently high mechanical strength without affecting the via wiring 3, the pad film 5, and the base container 2.

When pressure, heat, and vibration are applied to the pad film 5 through the welding, the adhesion of the pad film 5 with respect to the base bottom surface 2c or the via wiring 3 is deteriorated or the cracking or tearing occurs in the pad film 5 itself. Particularly, in a case where pressure, heat, and vibration are applied to the pad film 5 in the vicinity of the via wiring 3, and thus the pad film 5 does not any longer have adhesion, the pad film 5 and the via wiring 3 are not electrically connected to each other, the upper end surface of the via wiring 3 comes in contact with the electrolyte 7, and thus the via wiring is eluted in the electrolyte 7. In this regard, the welding portion 5a which does not affect the via wiring 3 is determined under the following welding conditions.

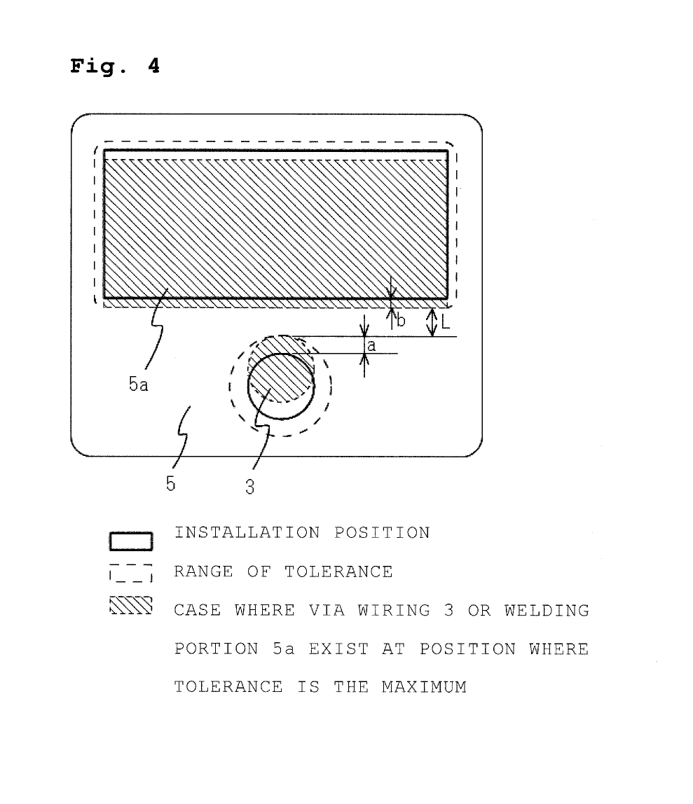

Here, as illustrated in FIG. 4, the welding conditions are determined as follows; tolerance relating to an installation position of the via wiring 3 to be protected is set to a, tolerance of a position of the welding portion 5a as a welding position is set to b, and the horizontal distance between the welding portion 5a and the via wiring 3 is set to L. In addition, in consideration of only the tolerance a relating to the installation position of the via wiring 3, L≧a×1.3 (Expression 1) is established as a relationship between the tolerance a and the horizontal distance L.

In addition, in consideration of the tolerance a relating to the installation position of the via wiring 3 and the tolerance b of the position of the welding portion 5a in the pad film 5, L≧(a+b)×1.026 (Expression 2) is established.

Even though the position of the via wiring 3 is deviated to the welding portion 5a side with respect to a designed position by the tolerance a or the position of the welding portion 5a is deviated to the via wiring 3 side with respect to the designed position due to the tolerance b, the electrochemical cell 1 which is formed as described above can avoid the influences of pressure, heat, and vibration generated at the time of the welding. Due to this, since the adhesion with respect to the base bottom surface 2c or the via wiring 3 of the pad film 5 is not deteriorated and cracks or tears does not occur in the pad film 5 itself, it is possible to secure the electrical connection between the pad film 5 and the via wiring 3, and to reliably protect the via wiring 3 from the electrolyte 7.

Sealing Ring 9

As illustrated in FIGS. 1A and 1B, the sealing ring 9 includes a rectangular frame-shaped cross section corresponding to the shape of the upper end surface of the base wall portion 2b of the base container 2, and is bonded to the upper end surface of the base wall portion 2b via a brazing material. As a material of the sealing ring 9, a material of which the coefficient of thermal expansion is close to the coefficient of thermal expansion of ceramics, for example, kovar which is formed of an iron-cobalt-nickel alloy can be used. In addition, the brazing material is formed of, for example, an Ag—Cu alloy or an Au—Cu alloy.

Lid 10

The lid 10, as illustrated in FIGS. 1A and 1B, is bonded to the upper surface of the sealing ring 9, and seals the base container 2. As a material of the lid 10, an alloy can be used of which the coefficient of thermal expansion is close to the coefficient of thermal expansion of ceramics, for example, kovar or 42 alloy which is subjected to a nickel plating, can be used. Specifically, a thin kovar sheet which has a thickness of about 0.1 mm to 0.2 mm, and of which a surface having the thickness about 2 μm to 4 μm is subjected to an electrolytic nickel plating or a non-electrolytic nickel plating, can be used. The lid 10 using the above-described materials can be welded to the sealing ring 9 through, for example, resistance seam welding or a laser seam welding, and therefore, it is possible to improve the air-tightness of the inside of the sealed base container 2.

In resistance seam welding which is used as a method of welding the lid 10 and the sealing ring 9, tack welding (spot welding) of the lid 10 is performed by causing the lid 10 to be in contact with the sealing ring 9, and disposing trapezoid-shaped roller electrodes which face each other at two points around the center on the long side of the lid 10 so as to allow a large current to flow at a low voltage in a short time. In this way, positional deviation does not occur during a welding operation from the vibration or the like due to the lid 10 which is temporarily fixed to the sealing ring 9.

Subsequently, for example, the base container 2 and the lid 10 are welded to each other by being moved along the long side from the end of the long side by the roller electrode. Next, the base container 2 and the lid 10 are rotated by 90 degrees and the short side is welded in the same way as described above. In this way, the welding is performed over the circumference of the lid 10. Both in the case of the temporary fixing as described above and this resistance seam welding, diffusion of gold and nickel occurs and a diffusion bonding layer which is air-tight and firm is formed on the interface between the lid 10 and the sealing ring 9. Due to this, the base container 2 is air-tightly sealed by the lid 10.

The welding of the lid 10 and the sealing ring 9 can be performed through laser scanning irradiation. After performing the tack welding in the same way as described above, the laser scanning irradiation is performed on the circumstance of the lid 10. Due to this, the diffusion bonding layer is formed on the interface between the lid 10 and the sealing ring 9. In this case, it is possible to reduce a melting temperature to a temperature of the brazing material by bonding a sheet of a brazing material made of silver and copper to the bonded surface of the lid 10.

In addition, the electrolyte 7 is formed of a liquid solvent or a supporting electrolyte at room temperature, and in a case of employing a process in which the container is filled with the electrolyte 7 before being sealed by the lid 10, the liquid may exist on the interface between the lid 10 and the sealing ring 9. Even in this case, the bonding can be performed through the seam welding. The seam welding may be performed by using the roller electrode or the laser scanning irradiation. It is considered that the reason why the airtight welding can be performed even when the liquid exists on the interface is that the liquid existing on the interface is evaporated and dispersed due to a rapidly increased temperature in the vicinity of the welded part at the time of the welding.

Note that, the upper end surface of the base container 2 and the lid 10 may be bonded via the brazing material instead of the sealing ring 9.

Manufacturing Method

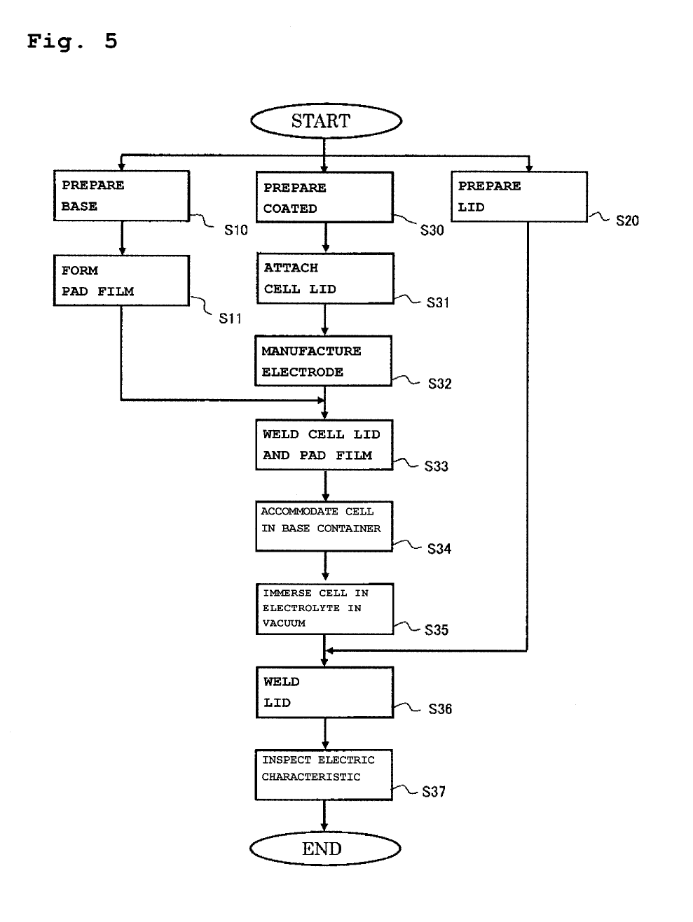

Next, a manufacturing method of the present embodiment will be described with reference to a manufacturing flow of an electric double layer capacitor illustrated in FIG. 5. First, as the external container, as illustrated in FIGS. 1A and 1B, the base container 2 which is formed into a concave shape, and the lid 10 are prepared. The base container 2 is configured such that the long side is 10 mm, the short side is 8 mm, the height is 1.8 mm, and the thickness of the bottom of the base container 2 is 0.38 mm. As a material thereof, a standard material is employed, which is used in the manufacturing of a package for an electronic component by using ceramics. The base container 2 is formed by bonding the ceramic green sheet corresponding to the wall portion 2b which is formed into a rectangular frame shape to the ceramic green sheet corresponding to the bottom portion 2a which is formed into a rectangular shape, and then baking the bonded sheets at a temperature of about 1500° C. The outer diameter of the via wiring 3 is set to be 0.2 mm, and four via wirings 3 are provided at the positive electrode side and the negative electrode side, respectively so as to directly pass through the base bottom surface 2c and the base lower surface 2d. In addition, the surface of the via wiring 3 is subjected to the nickel-gold plating. A pair of connection terminals 4 are disposed on the base lower surface 2d, and are connected to the via wiring 3. The connection terminal 4 is subjected to nickel based-gold plating (S10).

Next, a pair of pad films 5 which are formed of a vapor-deposited film of aluminum are formed on the base bottom surface 2c. The size of the pad film 5 is as follows; the short side is 2.4 mm, the long side is 3 mm, and the thickness is about equal to or greater than 15 μm (S11).

On the other hand, as the lid 10, a kovar substrate is prepared of which the size is such that the long side is 9 mm, the short side is 7 mm, and the thickness is 0.125 mm, and the surface thereof is subjected to the electrolytic nickel plating (S20).

Subsequently, the cell 6 is prepared. The collector of which the thickness is 20 μm and which is formed of aluminum is coated with an active material formed of activated carbon, a conductive auxiliary material, a binder, and a thickener through a coating method so as to make a sheet electrode (S30). After being cut to the appropriate length, the thin aluminum sheet of which the thickness is 80 μm, the width is 1.5 mm, and the length is 4 mm is attached to one end of the collector through the ultrasonic welding so as to make the cell lead 8 (S31). A separator which is formed of polytetrafluoroethylene is sandwiched between a pair of the positive and negative sheet-like electrodes to which the cell lead 8 is welded, and then a core is input thereinto so as to wind the sheet-like electrodes into a track form. Thereafter, a wound electrode is obtained by extracting the core and lightly crushing the gap (S32).

Subsequently, the ultrasonic welding is performed. The cell lead 8 is positioned by being bonded to the surface of the pad film 5 of the previously prepared base container 2. The ultrasonic welding is performed on each side of the cell lead 8 (S33). The oscillating frequency of the ultrasonic welding machine is set to be 40 kHz. The welding horn is made of iron, and the chip 20 for the ultrasonic welding which is formed of the same material as the welding horn is integrally provided at the tip end of the horn. The uneven pattern which is formed in a zigzag grid form at an interval of 0.2 mm (knurl) is provided over an area of 2.0×1.5 mm on the surface of the chip 20 for the ultrasonic welding. A peak to peak difference is 0.2 mm. A mode of the welding is set to a mode for controlling energy supplied to the cell lead 8 during the welding, a setting value of welding energy is set to be within a range of 50 J to 100 J, and a welding time is set to be within a range of 50 msec to 2000 msec. In order to perform the welding, the chip 20 for the ultrasonic welding is lowered onto the surface of the cell lead 8 formed of aluminum by an air mechanism, and then bites into the surface of the cell lead 8 in such a manner that the vibration is generated on the interface between the cell lead 8 and the pad film 5.

After the welding is performed, the cell 6 is accommodated in the base container 2 such that the cell lead 8 is folded. At this time, caution is taken so that the cell lead 8 is not mixed with the sealing ring 9 (S34). The reason for this is to prevent a short circuit in the cell.

Next, the base container 2 in which the cell 6 is accommodated is immersed in the liquid electrolyte 7 and is defoamed in a vacuum for an hour. Here, a supporting electrolyte of the electrolyte 7 is formed of spirobipyrrolidinium tetrafluoroborate, and a liquid mixture of polycarbonate and ethylene carbonate is used as a nonaqueous solvent (S35). Subsequently, returning to atmospheric pressure, the base container 2 in which the cell 6 is accommodated is taken out from the electrolyte 7, then the lid 10 is caused to be in contact with the sealing ring 9 in a nitrogen atmosphere, the tack welding is performed at two points on the long side, and, subsequently, the resistance seam welding is continuously performed on the long side and the short side of the lid 10 in this order so as to air-tightly seal the container (S36). In this way, the electric double layer capacitor of the embodiment is manufactured. Meanwhile, inspection of electric characteristic of the finally manufactured electric double layer capacitor is performed (S37). An inspection item is the measurement of equivalent series resistance and capacity, but is not limited thereto.

### Modification Example 1

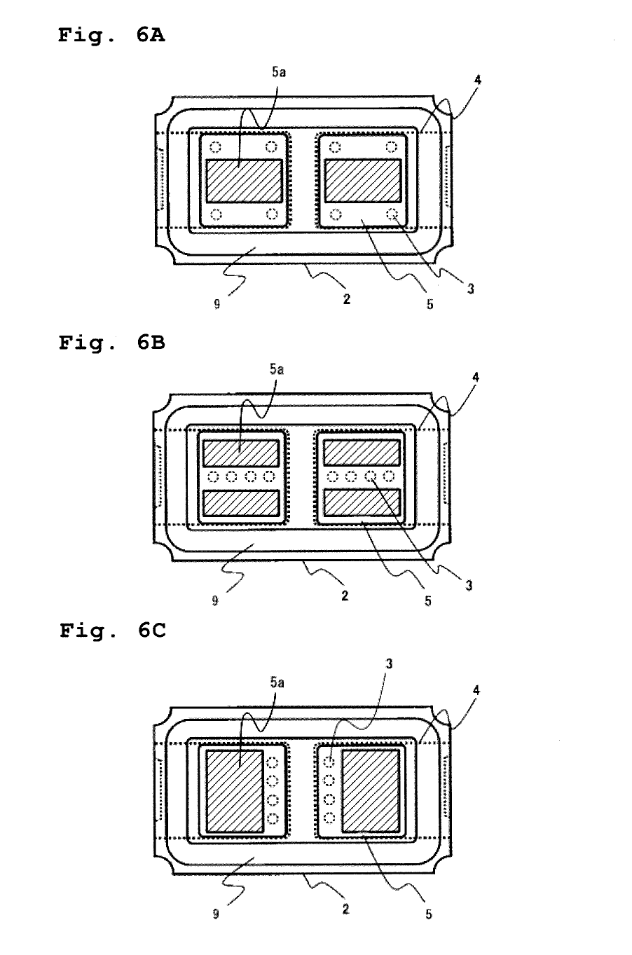

Modification example 1 of the embodiment is obtained by modifying the arrangement of the via wiring 3. As described above, if it is possible to meet a predetermined condition of the horizontal distance L between the welding portion 5a and the via wiring 3, it is possible to change the shape of the pad film 5 and the installation position of the via wiring 3. In other words, it is possible to enlarge an area of the pad film 5 and to change the position of the via wiring 3, as illustrated in FIGS. 6A to 6C.

FIG. 6A is an example of disposing the via wiring 3 so as to be close to the four corners of the pad film 5. Due to this, since it is possible to secure the welding portion 5a at the center of the pad film 5, it is easy to press the chip 20 for the ultrasonic welding, thereby improving workability at the time of performing the welding.

FIG. 6B is an example of disposing the via wiring 3 on the center line in the long side direction of the external container. Due to this, since it is possible to firmly weld at two places in one cell lead 8, it is possible to maintain the mechanical strength in an assembling process thereafter. In addition, even if the solder on one side is peeled off, it is possible to maintain the connection between the cell lead 8 and the pad film 5 through the welding on the other side.

FIG. 6C is an example of disposing the via wiring 3 so as to be close to the center of both electrodes of the pad film 5. Due to this, it is possible to secure the sufficient welding area with respect to the length direction of the cell lead 8.

### Modification Example 2

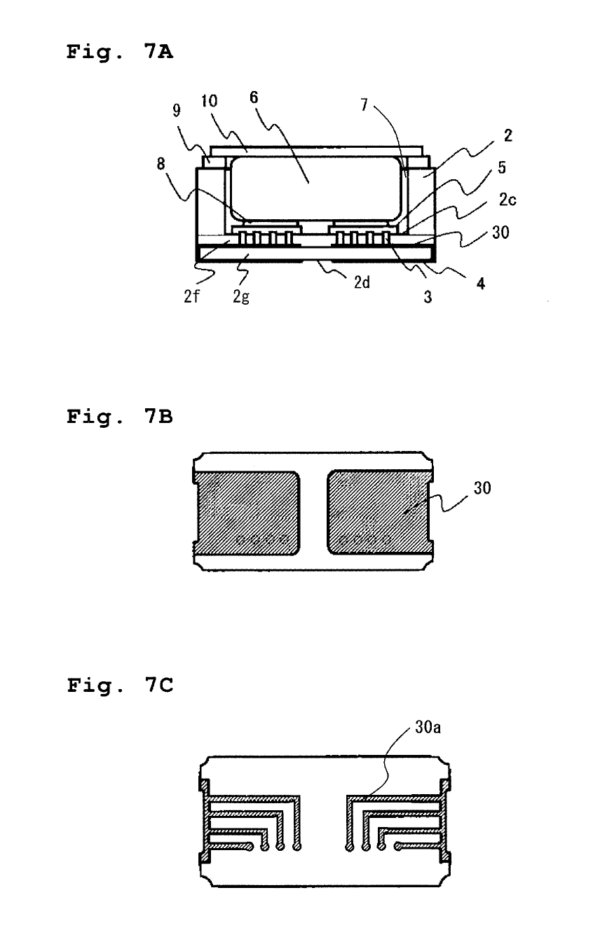

Modification example 2 of the embodiment will be described with reference to FIGS. 7A to 7C. FIG. 7A is a diagram illustrating a cross section of Modification example 2. FIG. 7B is a diagram illustrating a wiring pattern of Modification example 2, and illustrating an example of the wiring pattern in a solid form. FIG. 7C illustrates an example of another wiring pattern of Modification example 2. In the electrochemical cell 1 illustrated in FIG. 7A, the via wiring 3 does not directly pass through the base lower surface 2d from the base bottom surface 2c, but the via wiring 3 is fixed to the interface between two sheets of substrates, a first base bottom portion 2f and a second base bottom portion 2g which form the base bottom portion 2a. This interface is provided with a wiring pattern 30. The wiring pattern 30 is connected to the via wiring 3, horizontally extends so as to be exposed to the outer surface, and is connected to the connection terminal 4.

In the same way as described above, the pad film 5 has the aluminum film thickness of 5 μm to 100 μm. The pair of cell leads 8 which are connected to the cell 6 are connected to the pad film 5 through the welding. In addition, after the base container is filled with the electrolyte 7, the base container 2 is air-tightly sealed by the lid 10.

As illustrated in FIG. 7B, in the interface between the first base bottom portion 2f and the second base bottom portion 2g, the wiring pattern 30 formed of a metal film of tungsten or the like which is connected to the via wiring 3 is provided over a wide area with a solid form as shown by hatched lines. In addition, the wiring pattern 30 is horizontally drawn to the end portion of the long side of the second base bottom portion 2g and extends to the side surface. Then, the extension portion thereof is connected to the connection terminal 4. With such a wiring pattern in the solid form, it is possible to reduce a resistance value of the wiring pattern.

On the other hand, FIG. 7C illustrates that the linear wiring pattern 30a extends to the base side surface 2e from each point corresponding to the via wiring 3. In this way, the wiring pattern is not limited to the solid form. Here, in this case, a resistance value of the wiring pattern 30a becomes higher compared with the case illustrated in FIG. 7B. For this reason, it is necessary to determine the wiring pattern 30a in consideration of the number of the via wirings 3, the width and length of the wiring pattern 30a, and the sheet resistance value of the wiring pattern 30a.

As illustrated in Modification example 2, the via wiring 3 is not required to directly pass through the base lower surface 2d from the base bottom surface 2c, and is used for the large current discharge which the embodiment aims to achieve by combining the wiring patterns 30 and 30a which have the proper resistance value.

### Modification Example 3

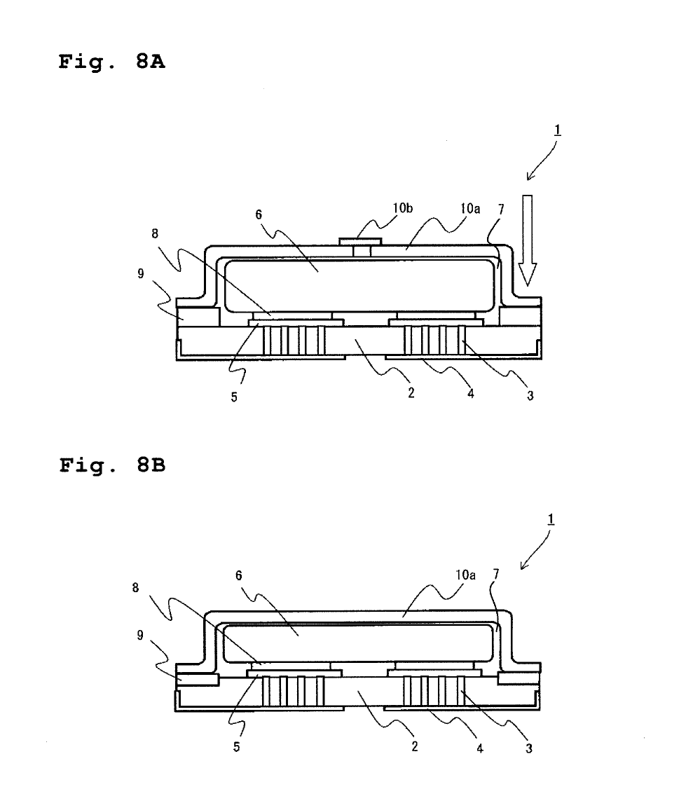

Modification example 3 of the embodiment will be described with reference to FIGS. 8A and 8B. The electrochemical cell 1 of Modification example 3 is provided with the base container 2 which is formed of only a ceramic flat plate and a cavity type lid 10a of a concave-shape metallic material which are components of the external container, and FIG. 8A illustrates a sectional view thereof. Similar to the embodiment, the cell 6, the pair of cell leads 8, and the electrolyte 7 are accommodated in the external container, and the cell lead 8 is connected to the pad film 5 which is formed on the base container 2 through the welding.

As illustrated in FIG. 8A, the cavity type lid 10a causes the opening portion to come in contact with the sealing ring 9 which is provided around the base container 2 to be welded so as to cover the cell 6 or the like. In this case, it is preferable that the seam welding is performed by using a laser. In addition, when performing the seam welding, scanning irradiation is performed from the arrow direction shown in FIG. 8A. In the resistance seam welding using the roller electrode, the roller electrode easily comes in contact with a stepped portion of the cavity type lid 10a, and thus it is difficult to properly bring the roller electrode into contact with the bonded portion.

In the cavity type lid 10a, a small hole is provided on a bottom surface portion (an upper end portion in the drawing) of the cavity type lid 10a. It is intended that after the base container 2 and the cavity type lid 10a are welded to each other, the small hole is filled with the electrolyte 7 so as to air-tightly seal the hole by using a sealing plug 10b. Due to this, due to the fact that the electrolyte 7 exists on the bonded surface between the metal layer for base bonding 5 and the cavity type lid 10a it is possible to prevent the efficiency of performing the sealing work from deteriorating. A material of the pad film 5 which is formed on the surface inside the base container 2 and a range of the thickness thereof, and the number of the via wirings 3 and the structure thereof, and a means of bonding the cell lead 8 and the pad film 5 to each other are the same as those described above, and thus the description thereof will not be repeated.

The electrochemical cell 1 illustrated in FIG. 8B is configured in the same manner as that illustrated in FIG. 8A except that the sealing ring 9 which is disposed around the planar base container 2 is fitted into a stepped portion provided in the base container 2, and a difference in height between the sealing ring 9 and the base inner surface is suppressed to be sufficiently small. Due to this, even when the cell 6 is disposed in the cavity type lid 10a after the cavity type lid 10a is filled with the electrolyte 7 in a state where the cavity type lid 10a is turned upside down, it is possible to reduce an amount of the electrolyte overflowing from the cavity type lid 10a. Accordingly, with such a configuration of FIG. 8B, even in a state where the cavity type lid 10a is filled with the electrolyte 7, the base container 2 and the cavity type lid 10a can be easily welded to each other. For this reason, a small hole in the cavity type lid 10a as illustrated in FIG. 8A is not necessary, and thus the sealing process performed using the sealing plug 10b can be omitted.

### Modification Example 4

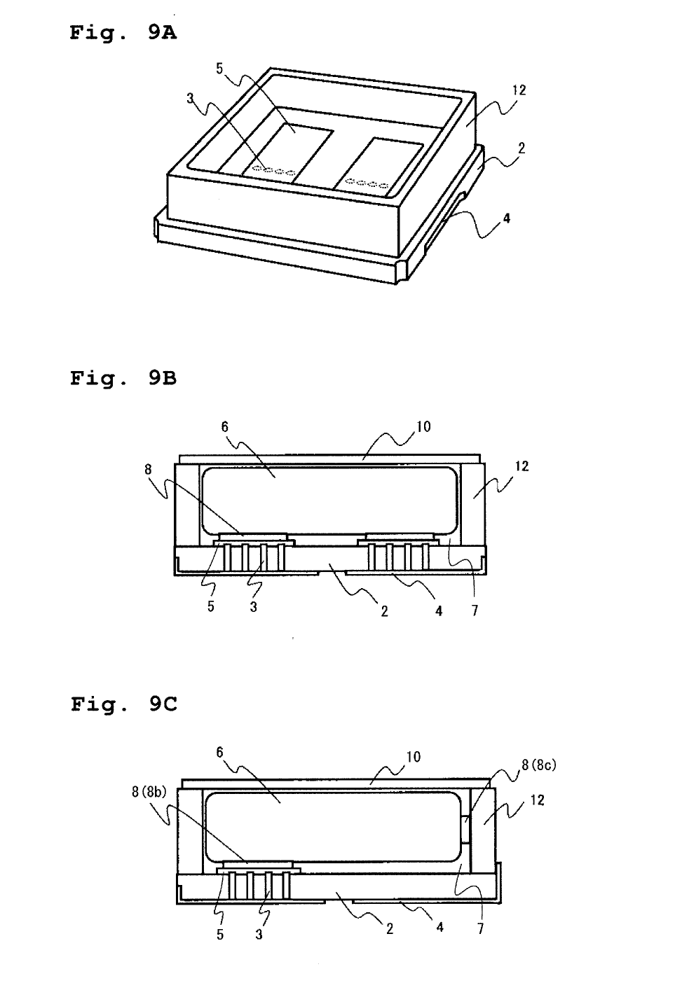

Modification example 4 of the embodiment will be described with reference to FIGS. 9A to 9C. FIG. 9A illustrates the base container 2 used in Modification example 4. In Modification example 4, the base container 2 is formed of the ceramic flat plate and a cylindrical metallic side wall 12 which is formed of a metallic material and boded to the flat plate, which are components of a concave container. The via wiring 3 which directly passes through the base wall portion 2b is provided on the base bottom surface 2c of the base container 2, and a pair of the pad films 5 are disposed on the via wiring 3. The metallic side wall 12 which is formed of the metallic material is selected such that the coefficient of thermal expansion thereof matches with that of the base container 2, and is bonded to the flat plate by using the brazing material. On the other hand, the opening portion on the side opposite to the bonded surface between the metallic side wall 12 and the flat plate forms the bonded surface between the lid 10 and the metallic side wall 12. In Modification example 4, the sealing ring 9 for sealing with the lid 10 is not necessary, and the metallic side wall 12 itself serves as the sealing ring 9. For this reason, the plating film which is formed of nickel and gold is applied to at least the surface bonded to the lid 10, and the lid 10 is in contact with the plating surface so as to be bonded thereto through the resistance seam welding or the laser seam welding.

FIG. 9B illustrates a sectional view of the electrochemical cell 1 having the flat-plate base container 2. The pair of cell leads 8 which are connected to the cell 6 are connected to the pad film 5 through a welding means, and are connected to the connection terminal 4 through the via wiring 3. The external container is filled with the electrolyte 7, and then air-tightly sealed by the lid 10. The material and the thickness of the pad film is the same as that described above. The metallic side wall 12 is formed of a metallic material, and thus can be formed into various shapes. Also the shape can be selected from a square, a track shape, an ellipse, a circle, and the like. Particularly, using a hollow pipe of a standardized article which is cut to a certain length, it is possible to freely determine the height of the electrochemical cell 1 and also to reduce the manufacturing cost.

Similar to FIG. 9B, the metallic side wall 12 which is formed of the metallic material is used in the electrochemical cell 1 illustrated in FIG. 9C, but the pad film 5 is an example limited only to the positive electrode side. A positive electrode cell lead 8b is connected to the pad film 5 through the ultrasonic welding, whereas a negative electrode cell lead 8c is connected to the inside of the metallic side wall 12 of the metallic material through the welding. Further, the connection terminal 4 corresponding to the negative electrode is formed by being electrically connected to the metallic side wall 12. Due to this, since the metallic side wall 12 is formed of the metallic material and a path through which the current flows is large, it is possible to reduce a wiring resistance value of the negative electrode side. Accordingly, it is possible to make the electrochemical cell 1 of the embodiment discharge a large current.

### Modification Example 5

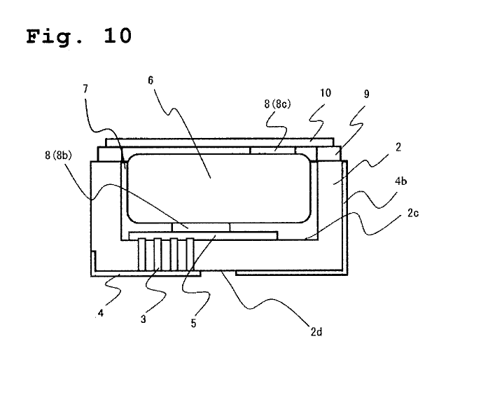

Modification example 5 of the embodiment will be described with reference to FIG. 10. FIG. 10 illustrates a cross section of the electrochemical cell 1 which is configured such that the pad film 5 which is formed of the aluminum film in the same way as that described above is provided on the base bottom surface 2c of the concave base container 2 which is formed of ceramics, and is connected to the connection terminal 4 through the via wiring 3. In Modification example 5, the via wiring 3 and the pad film 5 are provided only on the positive electrode side. In addition, the positive electrode cell lead 8b out of the pair of cell leads 8, which are connected to the cell 6 which is formed through the winding method or the laminating method, is connected to the pad film 5 through the ultrasonic welding, and thus it is possible to realize a sufficiently low connection resistance value.

On the other hand, the negative electrode cell lead 8c is connected to the inner surface of the lid 10. Even in a case where the material of the negative electrode cell lead 8c is a thin sheet or foil which is formed of aluminum, copper, or nickel, the negative electrode cell lead 8c can be connected to the lid 10 which is formed of the metallic material through a known welding method such as the ultrasonic welding method, a laser spot welding method, a resistance spot welding method, or an arc welding method. Accordingly, it is also possible to realize a sufficiently low connection resistance value with respect to the negative electrode side.

The connection terminal 4 on the negative electrode side extends to the sealing ring 9 along the base side surface 2e from the base lower surface 2d, and is electrically connected to the lid 10. A part to be extended is an extension portion 4b. Since it is possible to reduce a DC resistance value of the extension portion 4b by adjusting the length, width, and thickness of a conductor of the extension portion 4b, it is not necessary to greatly increase the wiring resistance value of the negative electrode side.

In order to realize an air tight container, the external container is filled with the electrolyte 7, and the lid 10 is welded to the sealing ring 9. Typically, in the lithium ion secondary batteries, the copper foil is used as the collector material of the negative electrode, and the thin sheet formed of nickel is used as the cell lead, but it is possible to apply Modification example 5 to the lithium ion secondary batteries. Accordingly, it is possible to manufacture the compact and thin lithium ion secondary battery with high reliability having high airtightness.

Meanwhile, the extension portion 4b is provided on the outer side of the container in Modification example 5. Without being limited to the connection method described above, the lid 10 and the connection terminal 4 may be connected to each other by providing a hole on the lower portion of the sealing ring 9 and forming a conductive material on the inner surface of the hole.

### Example

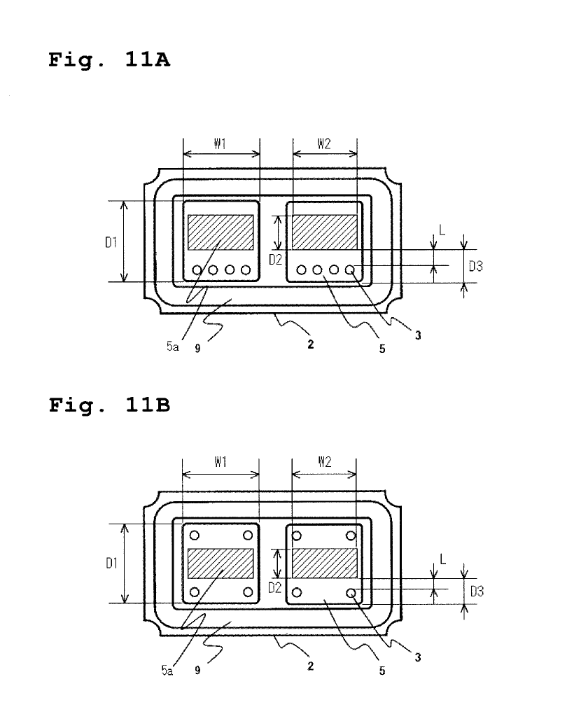

As Example and Comparative Example, as illustrated in FIGS. 11A and 11B, the size of the respective portions are defined in the electrochemical cell 1 which is configured such that the size of the bottom surface of the inside of the package is set to be 8.4 mm×3.4 mm, and the outer diameter of the via wiring 3 is set to be 0.2 mm. Here, in a case where a range (W2×D2) of the welding portion 5a is set to be 2.0 mm×1.5 mm in all of Examples and Comparative Examples, an evaluation of percent defective (%) will be performed with respect to the horizontal distance L between the welding portion 5a and the via wiring 3. As a design matter in this case, via tolerance a is set to be 0.15 mm. Meanwhile, as for the via wiring 3 in Example 1 and Comparative Example 1, as illustrated in FIG. 11A, each of the positive electrodes and the negative electrodes has four via wirings 3 disposed in one place under the pad film 5, and as for the via wiring 3 in Example 2 and Comparative Example 2, as illustrated in FIG. 11B, each of the positive electrodes and the negative electrodes has four via wirings 3, and two via wirings 3 are disposed in upper and lower portions with the pad film 5 interposed therebetween. Note that, the number of samples in each condition is set to be n=20.

The defect percentage represents a case where a retention ratio obtained from an initial capacity which is equal to or less than 50% by percentage, after performing a floating test (continuously charging a sample at 2.5 V, and storing the sample for 500 hours at an environmental temperature of 70° C.).

The ultrasonic welding is performed by setting the ultrasonic welding machine (BRANSON: 947 M) such that an oscillating frequency is 40 kHz, a welding time is 50 msec to 2000 msec, and a welding energy is 50 J to 100 J. In addition, tolerance b of the welding portion 5a is set to be 0.05 mm in consideration of the vibration in the horizontal direction generated when pressure-welding the horn.

The evaluation results are shown in the following Table 1.

TABLE 1

| | | | | Distance L | |
|---|---|---|---|---|---|
| | Range of | | Range in the | between | |
| | pad film | | vicinity of via | welding | Defect |
| | W1 × D1 | | wiring W1 × D3 | portion and via | percentage |
| | (mm) | Arrangement of via wirings | (mm) | wiring (mm) | (%) |
| Example 1 | 2.4 × 3.0 | Four via wirings × one place | 2.4 × 1.5 | 0.65 | 0 |
| Example 2 | | Two via wirings × two place | 2.4 × 0.75 | 0.275 | 0 |
| Comparative | 2.4 × 2.0 | Four via wirings × one place | 2.4 × 0.5 | 0.15 | 10 |
| Example 1 | | | | | |
| Comparative | | Two via wirings × two place | 2.4 × 0.25 | 0.025 | 45 |
| Example 2 | | | | | |

As indicated in the above Table 1, the defect percentage is 0 in Example 1 in which the horizontal distance L between the welding portion 5a and the via wiring 3 is 0.65 mm and in Example 2 in which the horizontal distance L between the welding portion 5a and the via wiring 3 is 0.275 mm.

On the other hand, the defect percentage becomes 10% in Comparative Example 1 in which the horizontal distance L is 0.15 mm. This is because that, as a result of the welding through the ultrasonic welding, the pad film 5 in the vicinity of the via wiring 3 does not have the adhesion any longer, or a defect such as the cracking or tearing occurs in the pad film 5 itself. In addition, the defect percentage becomes 45% in Comparative Example 2 in which the horizontal distance L is 0.025 mm. Similarly, as a result of the welding through the ultrasonic welding, the pad film 5 in the vicinity of the via wiring 3 does not have the adhesion any longer, or a defect such as the cracking or tearing occurs in the pad film 5 itself. That is, as the distance of L becomes shorter, the defect percentage is increased.

This means that in a case where the horizontal distance L between the welding portion 5a and the via wiring 3 is preferably 0.2 mm which is approximately the same distance as that of the outer diameter of the via wiring 3, or is more preferably 0.205 mm, it is less likely that the pad film 5 will be peeled off from the base bottom surface 2a or the like.

Here, in Expression 1, the horizontal distance L which is derived from the value 0.15 mm of tolerance a relating to the installation position of the via wiring 3 satisfies L≧0.195 mm. That is, in consideration of the tolerance a relating to the installation position of the via wiring 3, it is found that the defects do not occur when ensuring a machine is used which can achieve the horizontal distance L between the welding portion 5a and the via wiring 3 which is 1.3 or more times greater than the tolerance a.

In addition, in Expression 2, the horizontal distance L which is derived from the value 0.15 mm of the tolerance a relating to the installation position of the via wiring 3 and the value 0.05 mm of the tolerance b relating to the welding position of the pad film 5 satisfies L≧0.205 mm. That is, in consideration of the tolerance a relating to the installation position of the via wiring 3 and the tolerance b relating to the position of the welding portion 5a in the pad film 5, it is found that the defects do not occur when ensuring a machine is used which can achieve the horizontal distance L between the welding portion 5a and the via wiring 3 which is 1.026 or more times greater than the sum of the tolerance a and the tolerance b.

### SUMMARY

In Comparative Examples 1 and 2, since it is not possible to sufficiently secure the horizontal distance L between the welding portion 5a and the via wiring 3, due to the deviation occurring in the welding process, the cell lead 8 may be welded to the position of the via wiring 3. At this time, the adhesion with respect to the base bottom surface 2c or the via wiring 3 of the pad film 5 may be deteriorated and cracks and tears may occur in the pad film 5 itself due to pressure, heat, and vibration generated at the time of the welding. In contrast, in Examples 1 and 2, since it is possible to sufficiently secure the horizontal distance L between the welding portion 5a and the via wiring 3, the influence of pressure, heat, and vibration which are generated at the time of the welding can be avoided. Due to this, since the adhesion with respect to the base bottom surface 2c or the via wiring 3 of the pad film 5 can be maintained, or the cracking or tearing does not occur on the pad film 5 itself, it is possible to secure the electric connection between the pad film 5 and the via wiring 3, and to reliably protect the via wiring 3 from the electrolyte 7.

In addition, it is possible to provide a margin in the positioning accuracy at the time of the welding by sufficiently securing the distance between the via wiring 3 and the welding portion 5a, in other words, sufficiently securing an area of the pad film 5 in the vicinity of the via wiring 3. At this time, by disposing all of the via wirings 3 at the corner or center portion of the pad film 5, it is possible to secure a larger area of the welding portion 5a, and thus it is possible to secure the bonding strength between the pad film 5 and the cell lead 8. In addition, it is possible to sufficiently reduce the contact resistance.

The embodiment may take various other configurations without departing from the gist of the embodiment without being limited to Modification examples and Examples which are described in the present specification. For example, unless limited by claims, the lid may be formed of ceramics, glass, resin or the like without being limited to a metal material, and it is possible use various means for sealing depending on the material used.

What is claimed is:

1. An electrochemical cell comprising at least:
a base container;
a cell which is accommodated in the base container;
a plurality of cell leads which are extension portions of the cell;
a pad film which is formed of valve metal on a bottom surface of the base container; and
a base-embedded wiring which is connected to the pad film and is formed in a portion between the bottom surface and a lower surface of the base container,
wherein at least one of the cell leads and the pad film are fixed to each other through ultrasonic welding, and
wherein when a horizontal distance between a welding portion and the base-embedded wiring in the pad film is set to be L, and tolerance relating to an installation position of the base-embedded wiring is set to be a, L≧a×1.3 is established.

2. An electrochemical cell comprising at least:
a base container;
a cell which is accommodated in the base container;
a plurality of cell leads which are extension portions of the cell;
a pad film which is formed of valve metal on a bottom surface of the base container; and
a base-embedded wiring which is connected to the pad film and is formed in a portion between the bottom surface and a lower surface of the base container,
wherein at least one of the cell leads and the pad film are fixed to each other through ultrasonic welding, and
wherein when a horizontal distance between a welding portion and the base-embedded wiring in the pad film is set to be L, tolerance relating to an installation position of the base-embedded wiring is set to be a, and tolerance in a position of the welding portion in the pad film is set to be b, L≧(a+b)×1.026 is established.
